(19) United States
(12) Patent Application Publication
(10) Pub. No.: US 2017/0368676 A1
(43) Pub. Date: Dec. 28, 2017

(54) Skyplate

(71) Applicant: Channing Dewitt Wright, Atlanta, GA (US)

(72) Inventor: Channing Dewitt Wright, Atlanta, GA (US)

(21) Appl. No.: 15/193,029

(22) Filed: Jun. 25, 2016

(51) Int. Cl. B25H 3/04; B25H 3/00; A47F 7/00

(52) U.S. Cl. CPC B25H 3/04; A47F 7/0028; B25H 3/003

(57) ABSTRACT

A skyplate is the “knife block”of parts, tools, hardware or material.

An organizational tool, efficiency tool, part management system, machine or device used to build, create, imagine, house, store, contain and control parts, tools, hardware or material for reassembly, assembly, reconditioning or storage. I hereby state that the submission, filed in accordance with 37 CFR 1 .821(g) [or (h)], herein does not include new matter [or matter which goes beyond the disclosure in the international application].

### TITLE

Skyplate

### CROSS REFERENCES TO RELATED APPLICATIONS

Not Applicable

### STATEMENT REGARDING FEDERALLY SPONSERED RESEARCH OR DEVELOPMENT (IF APPLICABLE)

Not Applicable

### REFERNCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

The Skyplate will be utilized to build, create, imagine, house, store, contain and control parts, tools, hardware or material for reassembly, assembly, reconditioning or storage. It is a tool that will control and contain hardware for accountability at all times. It will organize parts and tools in assemblies and sub-assemblies for inspection and tool control.

In whatever industry it is used, its implementation leads to increased productivity and a decrease in time alloted for assembly, reassembly, reconditioning and storage. All “pieces to the puzzle” are now in one centralized location and ready for action at all times.

### BRIEF SUMMARY OF THE INVENTION

All parts, tools, hardware or material are controlled in one location; easily identifiable and accountable.

All parts, tools, hardware or material are accessible and available for component inspections.

The skyplate augments FOD (Foreign Object and Debris) prevention.

Localized parts, tools, hardware or material now exists in one location; versus various locations that lead to the loss of parts, tools, hardware or material.

### BRIEF DESCRIPTION OF THE SEVERAL VIEWS OF THE DRAWING

FIG. 1 illustrates a ¾ view of a fastener from a disassembled component or panel placed through a hole in the Skyplate for containment. A coresponding nut from the disassembled component or panel screws onto the fastener where it is contained.

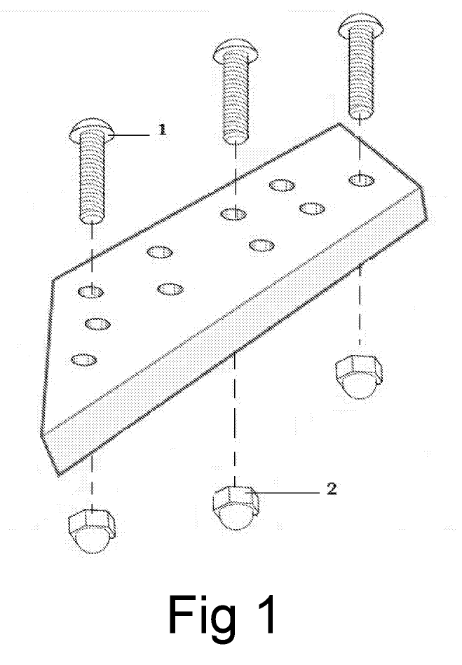

FIG. 2 illustrates a front view of hole(s) in a Skyplate for fasteners from disassembled components or panels to be placed and contained with all their coresponding hardware.

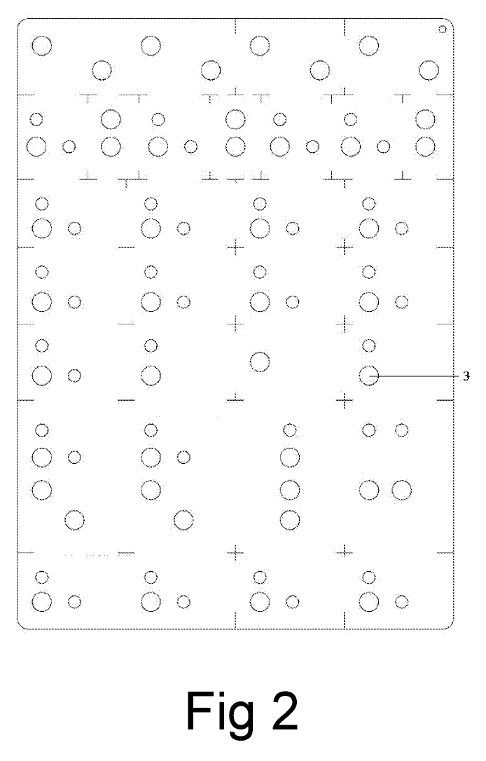

### DETAILED DESCRIPTION OF THE INVENTION

The skyplate will be used to build, create, imagine, house, store, contain and control parts, tools, hardware or material for reassembly, assembly, reconditioning or storage of one or more than one of the following:

a. Large movable equipment, such as tables and chairs, used to make a house, office, or other space suitable for living, working or engaging in an activity for enjoyment and recreation rather than a serious or practical purpose.

b. A building in which people meet for a particular activity.

c. A building for human habitation, especially one that is lived in by a family or small group of people.

d. An airplane, helicopter or transportation device or other machine capable of flight.

e. A boat, vessel or transportation device that travels on water.

f. A vehicle or transportation device used for traveling in space.

g. A vehicle, vessel or transportation device used to travel through time into the past, future, alternate reality or parallel universe.

h. A Vehicle or transportation device with a hull designed to operate completely submerged in the sea for long periods, equipped with an internal store of air or gaining air from the surface or an external source.

i. A thing made or adapted for a particular purpose, especially a piece of mechanical or electronic equipment.

j. A device or implement, especially one held in the hand, used to carry out a particular function.

k. An apparatus using or applying mechanical power and having several parts, each with a definite function and together performing a particular task.

l. A tool powered by any means to include internal combustion, powered by an electric motor, gasoline engine, fussion, fission and alternative fuels.

m. An object supply (a device) with mechanical or electrical energy.

1. A skyplate will maintain mulitple formats. The external form or appearance characteristic of the skyplate will vary. The composition of a skyplate will vary from metallic to non-metallic.
